(19) United States
(12) Patent Application Publication
(10) Pub. No.: US 2009/0183185 A1
(43) Pub. Date: Jul. 16, 2009

(54) Declarative and Extensible Process Definition

(75) Inventors: Benjamin Srour, Seattle, WA (US); Giedrius Zizys, Redmond, WA (US); R. Syam Kumar, Redmond, WA (US); Bahadir Onalan, Bellevue, WA (US); Pritam Sharma, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/015,482

(22) Filed: Jan. 16, 2008

(51) Int. Cl. G06F 9/46

(52) U.S. Cl. 719/328; 718/100

(57) ABSTRACT

An enterprise application may operate on a platform that is able to execute a solution pack that may have various configurable items incorporated into the solution pack. During runtime, the platform may present the configurable items in a user interface. The items may be embedded within the solution pack, which may contain various descriptors of a business process, including workflow definitions, data types handled in the process, and various rules or other definitions. The options made available within the solution pack may alter the workflow, alter conditions used within the workflow, change data types, or change any other element. The options may also be made available through an application programming interface to the platform.

### BACKGROUND

Enterprise or business process applications may be computer applications that perform many processes that are specific to an enterprise. In many cases, these applications may reflect many business processes that enable an enterprise or department within the enterprise to perform specific tasks. For example, an enterprise may have business processes that define how an order may be taken, which departments are affected by the order, how the order may be processed, and various interactions between accounting, shipping, and manufacturing departments. The interactions between the departments, along with the specific actions performed within the departments, may be a business process.

Enterprise applications may reflect the business processes of a department, division, or an entire enterprise. The applications may enable data to flow from one person or group to another and be processed in a procedure defined by the business process.

Enterprise applications are typically very expensive, and may be very inflexible as such applications may be either custom made for a specific business or may be a one-size-fits-all application.

### SUMMARY

An enterprise application may operate on a platform that is able to execute a solution pack that may have various configurable items incorporated into the solution pack. During runtime, the platform may present the configurable items in a user interface. The items may be embedded within the solution pack, which may contain various descriptors of a business process, including workflow definitions, data types handled in the process, and various rules or other definitions. The options made available within the solution pack may alter the workflow, alter conditions used within the workflow, change data types, or change any other element. The options may also be made available through an application programming interface to the platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with an execution engine.

FIG. 2 is a diagram illustration of an embodiment showing an example workflow.

FIG. 3 is a diagram illustration of an embodiment showing a user interface example of a configuration.

FIG. 4 is a flowchart illustration of an embodiment showing a method for an execution engine.

### DETAILED DESCRIPTION

A business process execution system may execute a solution pack that may contain a workflow definition as well as various configurable items. The configurable items may enable an administrator to configure the solution pack to align with specific business processes. The solution pack may be designed with many different configurable items and may allow an administrator to customize the application using dialog boxes or other simple user interface interactions without having to resort to programming.

The business process execution system may execute a workflow that is defined using various activities that may be triggered by various events. In some cases, an activity may change the state of an object, while in other cases, an activity may not change the state. The workflow may be defined in a declarative manner as opposed to a sequential or procedural manner, and may enable complex procedures to be rendered into simple rules or other declarative statements.

An example of a business process may be how information technologies requests are handled, routed, and resolved within an information technologies department. For example, a user may submit a hardware upgrade request or a help request due to a printer problem. The requests may be analyzed and routed to the appropriate person for resolution. A hardware upgrade request may be routed to a manager for approval, purchasing to order new hardware, and to a technician for installation. Such a request may be processed over a period of days. A printer problem request may be routed to a technician who may be able to respond within minutes. In each request, a business process may describe the interactions between the various persons, the urgency of the requests, and how a request may be routed, approved, logged, verified, or other actions that may be taken.

The configurable items within a solution pack may be exposed by a solution developer to enable customization of a solution. The configurable items may include variations on the data structure used, selection of various activities that may be performed on certain conditions, variables that may be constructed to form a trigger condition for an activity, or any other variable.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

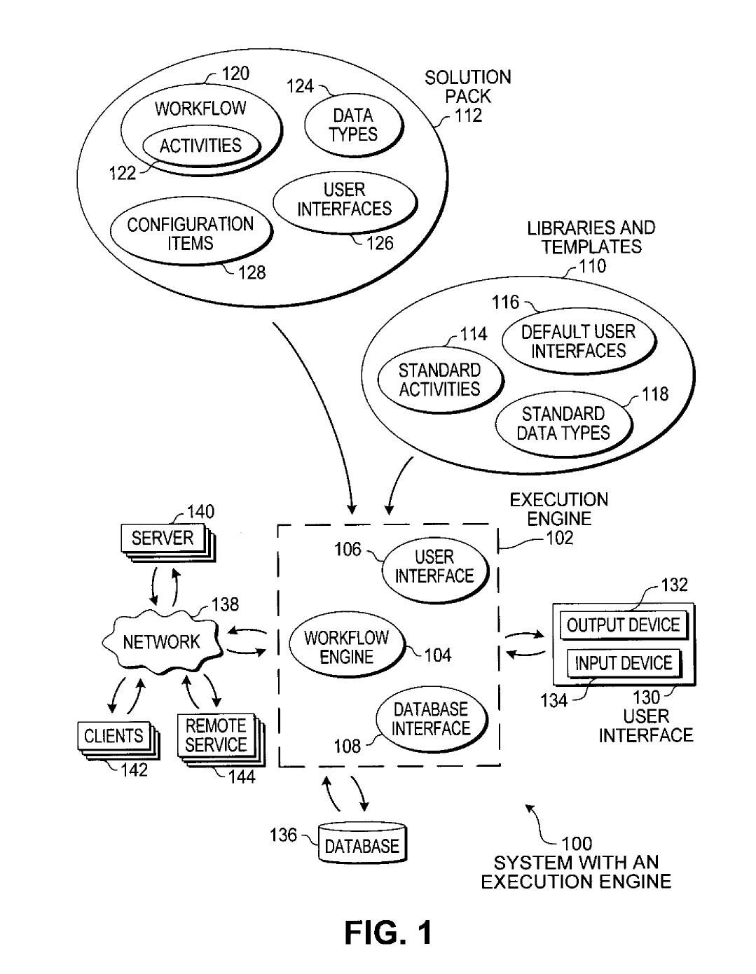

FIG. 1 is a diagram illustration of an embodiment 100 showing a system with a business process execution engine. Embodiment 100 is an example of various functional elements that may be used to deliver a business process application.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 illustrates a mechanism for delivering business process applications. A business process application may be a computer application that may follow, define, or assist in the interactions between various people, departments, functions, or other elements of a business. In many embodiments, a business process application may be the core function of a business, department, or other organization.

For example, a business process application within a retail furniture outlet may display available inventory, receive orders, ensure payment of orders, schedule deliveries, and other functions of the business. In some cases, a business process application may be used within a department, such as shipping and receiving, to monitor and track actions within the department.

In many implementations, a business process application may operate on one or more server computers and may access one or more databases. In many cases, a business process application may be accessed by many different users on many different client devices.

A business process application may be run on an execution engine 102 that may comprise a workflow engine 104, a user interface generator 106, and a database interface 108. The workflow engine 104 may determine a workflow from a declarative definition and may execute the workflow by monitoring trigger conditions and executing activities based on the trigger conditions.

The user interface generator 106 may create various interactive user experiences. The user interface generator 106 may be a mechanism that creates a display or other output that is rendered on a local or remote hardware device. The user interface generator 106 may use various definitions for the content and layout for a user interface. In some cases, the content and layout may be automatically generated, and in other cases, the content and layout may use templates that may be default or library templates. Some embodiments may have user interfaces fully or partially defined within a solution pack.

In some instances, the user interface 106 may create a web interface that may communicate with a user or administrator over hyper text transfer protocol (HTTP) or some other mechanism. In other cases, a local user interface 130 may be used that may have various hardware output devices 132 and input devices 134.

Such output devices 132 may be various visual displays, audio output, tactile devices, hardcopy output, or any other output devices. In a typical use, the output device 132 may be a computer monitor. Examples of input devices 134 may be keyboards, pointing devices such as a mouse, stylus, or trackball, or other input devices.

The execution engine 102 may include a database interface 108. The database interface 108 may perform many functions, including instantiating data sets based on data types, storing and retrieving data and metadata, performing queries against a database, or other operations. In many cases, the database interface 108 may communicate with a local database 136 that may be available on a server that may host the execution engine 102. In other cases, the database 136 may be located on a different server and available remotely. In still other cases, a combination of local and remote devices may be used to perform the functions of the database 136.

The execution engine 102 may contain various low level functions or operations that may be invoked by the solution pack 112. In some embodiments, a set of libraries and templates 110 may be called by portions of the solution pack 112.

The libraries and templates 110 may include various activities 114. Activities 114 may be a function or operation that may be performed when a trigger condition is met. In some cases, an activity 114 may be a simple operation such as store data in the database 136. In other cases, an activity 114 may be very complex and comprise many different steps or operations.

The libraries and templates 110 may include default user interfaces 116 and a set of standard data types 118. The default user interfaces 116 may include templates that may be used to create user interface displays by a solution pack 112, as well as user interfaces for administrative functions. The standard data types 118 may be default data types that may be used by a solution pack 112 or for administrative functions.

A solution pack 112 may contain various components that may define a business process application. These components may be used by the execution engine 102 to deliver a business process application. The components may include a workflow definition 120, user interfaces 126, report definitions, and other components of a business process application. The solution pack 112 may also include lower level components such as datatypes 124 and configuration items. The execution engine 102 may receive and validate the solution pack 112, then execute the solution pack to deliver the business process application.

The solution pack 112 may address any type of business process. For example, one solution pack may be created for processing information technology work requests. Another solution pack may be created for processing orders within a warehousing department, while other solution packs may be created for other business processes. Each business process may be executed on a common execution engine 102, and the business process may cause the execution engine 102 to perform certain functions in certain manners with certain criteria.

The solution pack 112 may be considered metadata in that the solution pack 112 may define the processes operating with and the characteristics of the data that may underlay the business process. Such metadata may include the workflow definition 120, various data types 124, user interfaces 126, and configuration items 128. Some embodiments may include many other types of definitions and metadata.

The solution pack 112 may contain a workflow definition 120. The workflow definition 120 may comprise various activities 122 and conditions that may trigger the various activities 122. In many cases, an activity may be a state changing activity, where the state of an object may be altered. In other cases, an activity may be a non-state changing activity where a condition may trigger an action that does not change the state of an object. In many embodiments, a workflow 120 may be defined in terms of progressing the state of an object from one state to another. A condition may trigger each step, which may be defined in an activity.

The conditions and activities within the workflow 120 may be defined in a declarative manner. In many embodiments, such a declarative manner may use a form of rules or other independent declarations. The rules may be executed independently and may together define a workflow.

The solution pack 112 may include various data types 124. The data types 124 may include definitions and other metadata about the data that may be handled and processed within the business process application. In some cases, the data types 124 may include persistently stored in the database 136, while in other cases the data types 124 may include temporary variables that may not be persisted.

The data types 124 may include conditions or limits on the data. For example, a data type definition may include a number variable definition, a name for the variable, and a limit definition for the acceptable ranges of the data.

The solution pack 112 may include definitions for various user interfaces 126. In some cases, the user interfaces 126 may include formatting and content definitions that may be used by the user interface component of the execution engine 102 to generate a visual or other display and process various data received from a user.

Various configuration items 128 may be included within the solution pack 112. The configuration items 128 may be any variable, data type, condition, activity, or other portion of a solution pack 112 that a solution pack developer may make available for alteration by a user or administrator. The configuration items 128 may be detected by the execution engine 102, presented for modification, and used to change various characteristics of the executing solution pack 112.

In many embodiments, the execution engine 102 may be configured to operate on a server device. While operating, the execution engine 102 may connect to a network 138 and, in some cases, interface with various servers 140, clients 142, and remote services 144. The network 138 may be a local area network, a wide area network, and may include the Internet.

The servers 140 may provide file storage, database access, or other locally provided services. The clients 142 may be access points for administrators and other classes of users. In many embodiments, client devices may range from computer terminals to handheld wireless devices such as laptops, mobile phones, handheld scanners, or other devices. The remote services 144 may be any service that may be accessed over a network, including the Internet. In many cases, a remote service may be provided over the Internet for data storage, data processing, or other operations. In a typical remote service arrangement, a third party may host and manage the remote service on various subscription bases. In some embodiments, a service may be provided through a connection to a service-providing device. An example may be a connection through a serial port to a service-providing appliance or other device.

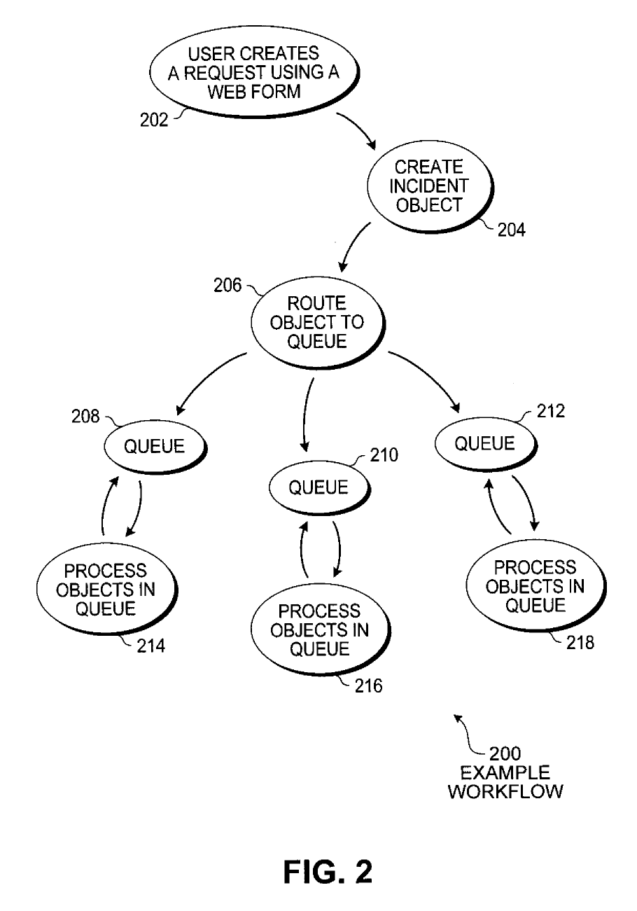

FIG. 2 is a diagram illustration of an example embodiment 200 of a workflow. The example workflow is merely one application of a workflow and is selected to highlight some features of a typical workflow.

Embodiment 200 is an example workflow that may simply describe a business process for handling a request, such as a request for information technology assistance.

In the workflow, a user may create a request using a web form in block 202. From the request, an incident object may be created in block 204. The object may be routed to a queue in block 206, and the queue may be one of the queues 208, 210, and 212. Each of the queues 208. 210, and 212 may have a separate process for handling the objects in blocks 214, 216, and 218, respectively.

Embodiment 200 is a simplified example of a business process that may be used to process requests. Depending on the characteristics of the request, the request may be processed by three different queues, each of which may process the request in a completely different manner.

Continuing the example of an information technology request, some requests may be urgent and may be processed immediately. Some requests may be handled by a specialized technician with certain training or access. Other requests may be approved by a manager prior to being performed. In each case, the request may be placed in a different queue and processed according to the business process assigned for the queue.

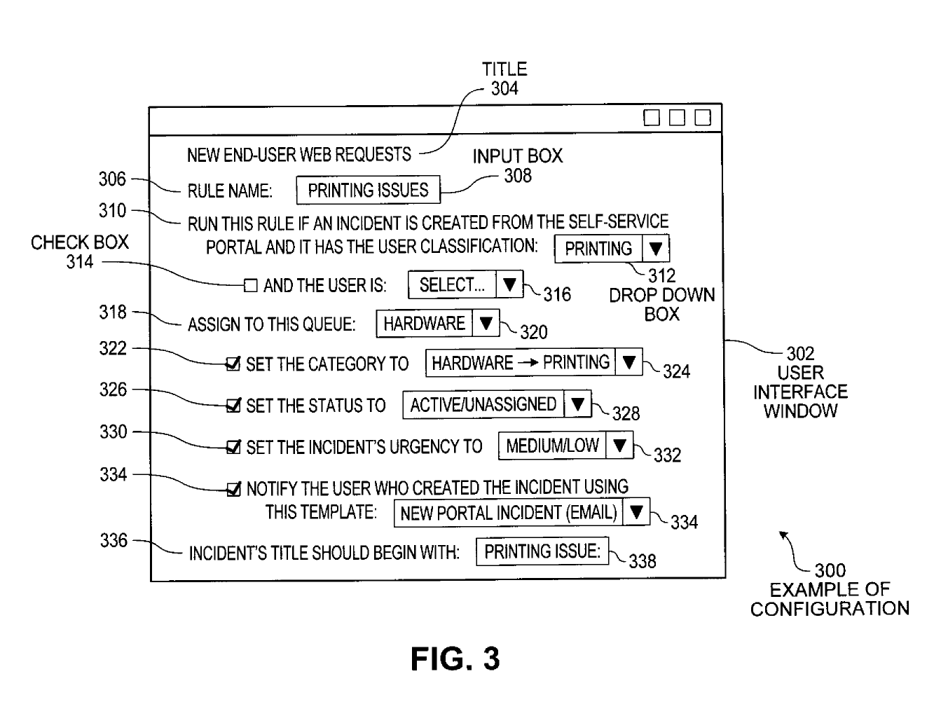

Part of the business process may be the characteristics of how the object is routed in block 206. FIG. 3 illustrates a user interface example of such characteristics as made available through a configuration user interface.

FIG. 3 is a diagram illustration of an embodiment 300 showing an example of a configuration user interface. Embodiment 300 is an example of a user interface that is shown merely to highlight various functional characteristics of configuration elements in a solution pack.

Embodiment 300 is an example of a configuration user interface that may be used to set various configurable parameters with in a solution pack. More specifically, embodiment 300 illustrates the construction of a rule that may be used in block 206 for determining the characteristics of an incident object. The characteristics may then be used within the business process to determine how the incident object may be processed.

The user interface window 302 may be generated by a user interface definition within a solution pack. In many cases, the user interface definition may be an HTTP, XML, or other definition that may be used for defining the items to display on an interface, as well as to filter input data for acceptable values.

The user interface window 302 may be a user interface that is accessible by an administrator or someone with elevated privileges. The user of the user interface of embodiment 300 may be defining the business process that may be followed by other users in the organization. In many cases, such configuration may be performed when a business process application is deployed, and may or may not be changed thereafter. In some cases, a configuration item may be changed to tweak an existing business process.

The user interface window 302 may contain a title 304. Each user interface definition may include various nonfunctional components such as titles, graphics, colors, and text.

The example displayed in the user interface window 302 may be designed to define a rule that may classify a request for printer related issues from an information technologies organization. The rule defined in embodiment 300 has several variables.

The rule name 306 may be input in a text box 308 as “Printing Issues”. A text box input may enable an administrator or user to type a string. In some embodiments, the string may be checked to conform to certain parameters. For example, the string may be defined to be longer than a minimum size and shorter than a maximum size. In another example, the string may be tested to see if certain characters, words, or phrases are used. Many other checks may be applied to an input box, while in some embodiments, no checks may be applied at all.

Item 310 states that the rule is run if an incident is classified as “Printing” in the drop down box 312. The drop down box 312 may have two or more selections from which an administrator may choose. In the case of a drop down box, an administrator may be limited to the number of choices given.

The administrator may be able to select a check box 314 to add an additional user qualification to the rule using the drop down box 316.

The items 310 and the optional item with the check box 314 may define a condition for triggering the rule.

Item 318 assigns the object to a queue selected in the drop down box 320, here shown as “Hardware”.

In the example rule, item 318 is a mandatory portion of the rule. Other items 322, 326, 330, and 334 may be optionally added to the predicate portion of the rule. Each item within the predicate may cause a separate activity to be executed when the original condition of the rule is met.

Item 322 may set the category of the incident to “Hardware ->Printing” as defined in the drop down box 324. Item 326 may set the status of the incident to “Active/Unassigned” using the drop down box 328. Similarly, item 330 may set the incident's urgency to “Medium/Low” from the drop down box 332. The incident's title may begin with the text “Printing Issue:” as defined in text box 338.

In some embodiments, the rule defined in embodiment 300 may reset the values of the category, status, and urgency for any incident meeting the definition in items 310 and 314. The original incident may have a category, status, or urgency defined when a user created an incident report, but the rule of embodiment 300 may be used to reset one or more of those values.

The embodiment 300 may be used to create several different rules that may be implemented in a solution pack. For example, the rule displayed in embodiment 300 may be a default rule. A separate rule may be created where the check box 314 may be selected and the user in block 316 may be selected. In the separate rule, when the user is selected to be “Developer”, the status of item 326 may be selected to be “Medium/High”. This is an example of using a configuration user interface to create one or more many new rules that may be executed within a solution pack.

In many systems, configuration items within a solution pack may allow a large amount of flexibility and tailoring to be performed on a given business process application. Because the solution pack may use a declarative definition, rather complex and intricate workflows may be created by defining relatively simple rules for various conditions.

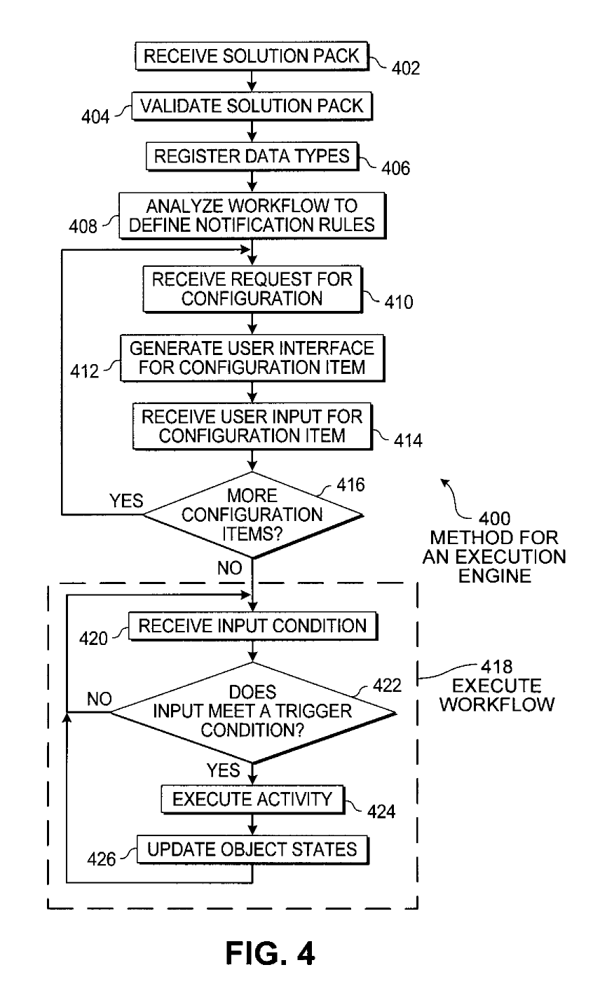

FIG. 4 is a flowchart illustration of an embodiment 400 showing a method that may be used by an execution engine. Embodiment 400 may illustrate one simplified method performed by an execution engine, such as the execution engine 102.

Embodiment 400 is merely one example of such a method. Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form. In some embodiments, the method of embodiment 400 may be performed in a recursive fashion.

Embodiment 400 performs three basic operations: inputting a solution pack, configuring the solution pack, and executing the solution pack.

The solution pack may be received in block 402 and verified in block 404. In some embodiments, the solution pack may be verified by analyzing and resolving the various rules and conditions of the solution pack and looking for any inconsistencies. An inconsistency may arise when a circular loop is established, when an item is improperly referenced, or some other condition.

Data types within the solution pack may be registered in block 406. In some embodiments, the data types may define data structures that may be stored in a database and that may be referenced with various activities and rules within a workflow.

The workflow definition may be analyzed in block 408 to define various notification rules. The notification rules may be the trigger conditions on which various activities may be executed. The notification rules may be created based on a declarative definition of the workflow, and used to trigger various state changing and non-state changing activities.

In blocks 410-416, a simplified process for configuring the components of a solution pack is presented. The solution pack may be designed to operate in a default manner without configuration. In some cases, a minimum set of configuration items may be used to enable a solution pack to operate. In some cases, a configuration item may be set after execution begins.

A request may be received for configuration in block 410. In many embodiments, the request may be made by an administrator or other use that has access privileges to configure the solution pack. In many embodiments, a regular user of the business process application may not have access permissions to perform a configuration.

A user interface for the configuration item may be created in block 412. An example of such a user interface may be the embodiment 300. The user input for the various configuration items may be received in block 414. An example of such user input may be the selections of the various drop down boxes and the text input in the text boxes of embodiment 300. Other embodiments may use any type of input mechanism to input any type of data.

If more configuration items are to be processed in block 416, the process may return to block 410. Otherwise, the process may begin the workflow execution of block 418.

The workflow execution of block 418 may comprise receiving an input condition in block 420. If the input condition fulfills a trigger condition in block 422, the predicate activity may be executed in block 424. In some embodiments, an activity may update an object state in block 426.

The input condition of block 420 may be any condition or input parameter. In some cases, an execution engine may monitor a remote service, server, or client to determine if an input condition has been met. In other cases, an activity may change a variable, setting, or state of an object which may serve as an input condition. In many embodiments, a rule may be defined to have two or more input conditions that may be defined in any manner of Boolean or other logic.

In many embodiments, an execution engine may have an application programming interface (API) through which other programs, applications, or services may query the execution engine or send data to the execution engine. In some cases, various input conditions for rules within a solution pack may come through the API.

The API may provide external programs an access point to the solution pack that is being executed. In many embodiments, an API may provide access to default variables within the execution engine and also access to those variables, conditions, and other elements defined within the solution pack. In many cases, configuration elements may be queried and/or set through an API.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a solution pack comprising metadata describing a business process, said metadata comprising a workflow definition, a set of data types, and at least one configuration option;
validating said solution pack;
registering said data types in a database;
analyzing said workflow definition to define a set of notification rules;
create a user interface comprising said at least one configuration option;
presenting said user interface;
receiving a set of settings corresponding to said at least one configuration option; and
performing said workflow using said setting and said set of notification rules.

2. The method of claim 1 further comprising:
providing access through an application programming interface to a standard set of data, said standard set of data not defined in said solution pack; and
providing access through said application programming interface to data corresponding to said set of data types.

3. The method of claim 1 further comprising:
providing access through an application programming interface to a standard set of metadata, said standard set of metadata not defined in said solution pack; and
providing access through an application programming interface to said metadata comprised within said solution pack.

4. The method of claim 1, said workflow definition comprising a plurality of object states and a plurality of state changing activities.

5. The method of claim 4, each of said state changing activities having at least one trigger condition.

6. The method of claim 5, said at least one configuration option being configured to vary at least one trigger condition.

7. The method of claim 5, said at least one configuration option being configured to substitute a first of said plurality of state changing activities for a second of said plurality of state changing activities.

8. The method of claim 1, said user interface being at least partially defined in said solution pack.

9. The method of claim 1, said metadata further comprising at least one data integrity condition for one of said data types, said method further comprising:
receiving a first value for a first of said data types; and
determining that said first value is acceptable based on said at least one data integrity condition.

10. The method of claim 1, said business process being a business process within an information technologies organization.

11. The method of claim 5, said business process comprising handling change requests for computer equipment.

12. A system comprising:
a database;
an execution platform having a workflow engine, a user interface, and a database interface, said execution platform configured to:
receive a solution pack comprising metadata describing a business process, said metadata comprising a workflow definition, a set of data types, and at least one configuration option;
validate said solution pack;
register said data types in a database;
analyze said workflow definition to define a set of notification rules;
create a user interface comprising said at least one configuration option;
present said user interface;
receive a set of settings corresponding to said at least one configuration option; and
perform said workflow using said setting and said set of notification rules; and
an application programming interface.

13. The system of claim 12, said application programming interface being adapted to provide access to said metadata.

14. The system of claim 12, said application programming interface being adapted to provide access to data stored according to said data types in said database.

15. The system of claim 12, said workflow definition comprising a plurality of object states and a plurality of state changing activities.

16. The system of claim 15, each of said state changing activities having at least one trigger condition.

17. The system of claim 16, said at least one configuration option being configured to vary at least one trigger condition.

18. The system of claim 16, said at least one configuration option being configured to substitute a first of said plurality of state changing activities for a second of said plurality of state changing activities.

19. A business process execution system comprising:
a solution pack comprising metadata, said metadata comprising:
a plurality of object state definitions;
a plurality of state changing activities, each of said state changing activities being defined with at least one triggering condition;
a plurality of non-state changing activities, each of said non-state changing activities being defined with at least one triggering condition;
a set of configuration options, at least one of said configuration options being configured to replace a first of said state changing activities with a second of said state changing activities;
an execution engine configured to:
receive said solution pack;
generate a user interface comprising at least one of said configuration options;
receive a user input for said at least one of said configuration options; and
execute said solution pack using said configuration options, said plurality of state changing activites, and said plurality of non-state changing activities.

20. The business process execution system of claim 19, at least a portion of said user interface being defined in said solution pack.
